(19) United States
(12) Patent Application Publication
(10) Pub. No.: US 2024/0259443 A1
(43) Pub. Date: Aug. 1, 2024

(54) DELAYING CLIENT CONTENT DOWNLOADS BASED ON PARTICIPANT ATTENTION LEVEL

(71) Applicant: Cisco Technology, Inc., San Jose, CA (US)

(72) Inventor: Qiujun Zhao, Hangzhou (CN)

(21) Appl. No.: 18/162,076

(22) Filed: Jan. 31, 2023

(51) Int. Cl. H04L 65/403

(52) U.S. Cl. CPC H04L 65/403

(57) ABSTRACT

A method, computer system, and computer program product are provided for providing a collaboration session. Media content is received at a server for delivery to a plurality of user devices connected to a collaboration session. Attention data indicating a degree to which a user is engaged in the collaboration session is received, wherein the attention data indicates a screen occupancy of a window corresponding to each user. The attention data is analyzed to determine an order in which the media content is transmitted to each user device of the plurality of user devices, wherein the order prioritizes user devices whose users are more engaged in the collaboration session over user devices whose users are less engaged based on the attention data. The media content is transmitted by the server to each user device of the plurality of user devices according to the order.

### TECHNICAL FIELD

The present disclosure relates generally to collaboration sessions, and more specifically, to sharing content to clients that are participating in a collaboration session in a manner that delays downloads of the content based on the attention level of participants.

### BACKGROUND

A collaboration session, also referred to as a teleconference or webinar, is a form of teleconferencing in which multiple participants can exchange audio and/or video data, present documents or other content to each other, and/or perform other operations in order to remotely collaborate on a task. Many approaches to collaboration sessions typically employ a central server that facilitates the exchange of data between the various participants. However, during large collaboration sessions, the number of participating clients that are simultaneously attempting to download content from the server may exceed the server's capacity to satisfy the requests.

### BRIEF DESCRIPTION OF THE DRAWINGS

FIG. 1 is a block diagram of a networking environment for providing a collaboration session, according to an example embodiment.

FIGS. 2-4 are diagrams depicting graphical user interfaces, according to example embodiments.

FIG. 5 is a flow chart of a method of transmitting media content during a collaboration session, according to an example embodiment.

FIG. 6 is a block diagram of a device that may be configured to participate in and/or provide a collaboration session, as presented herein.

### DETAILED DESCRIPTION

### Overview

According to one embodiment, techniques are provided for providing a collaboration session. Media content is received at a server for delivery to a plurality of user devices connected to a collaboration session in which a corresponding plurality of users are participating. Attention data indicating a degree to which a user is engaged in the collaboration session is received from each user device of the plurality of user devices, wherein the attention data indicates a screen occupancy of a window corresponding to each user of the plurality of users. The attention data is analyzed to determine an order in which the media content is transmitted to each user device of the plurality of user devices, wherein the order prioritizes user devices whose users are more engaged in the collaboration session over user devices whose users are less engaged based on the attention data. The media content is transmitted by the server to each user device of the plurality of user devices according to the order.

### EXAMPLE EMBODIMENTS

During a collaboration session (e.g., a webinar, teleconference, etc.), a host or other party may provide media content to a server that the server then transmits to the clients of each user device participating in the collaboration session. For example, the media content can include a virtual stage background, a logo, a slide of a slideshow, or any other desired media. However, when each participating user device attempts to download the media content at the same time, a content delivery network (CDN) server may not be able to satisfy the demand. For example, a collaboration session may have thousands of participants, and the CDN server's capacity may be greatly exceeded by such a large number of download requests.

One solution that ensure that a server can satisfy each request is to delay the downloads over a period of time, so the server only handles a smaller subset of requests at a given time. Thus, the individual downloads can be staggered to lessen the number of requests at any moment in time. For example, client downloads can be delayed by randomly selecting subsets of clients and applying different delay times to each subset. To continue this example, if there are 10,000 participating clients, the clients may be split into ten subsets of one thousand clients each; a first subset may be served the content immediately to within one second, a second subset may be delayed after the first subset and subsequently be served from one to two seconds, and the like. However, this approach would cause a last subset of clients not to receive the content until a nine to ten second delay, which may be deemed a poor user experience.

In contrast, present embodiments provide an approach to delaying content downloads for clients in a manner that is based on the attention level of each user. In particular, data is gathered from user devices that is indicative of how much attention a user may be paying to the collaboration session, and downloads can be prioritized to provide the content to more attentive users before serving less attentive users. Thus, downloads are spread out so that if any clients encounter a long delay, the users who experience the delay may not even notice.

Present embodiments provide a novel approach to determining the attention level for client devices. In particular, attention level can be determined based on a screen occupancy of a window of the client for each user device. Thus, users who have maximized the window may be prioritized over users who have not maximized the window. The attention level can be normalized with respect to screen size, so that the prioritization does not favor displays that happen to have larger resolutions. Moreover, if another application's window overlaps the window of the collaboration session client's window, the area that is overlapped may further affect the attention level. Thus, a user who has another window (e.g., a web browser) over the client's window may be deemed less attentive and delayed accordingly.

Thus, present embodiments improve the field of telecommunication by improving the user experience with regard to content downloads during a collaboration session. Present embodiments can provide the practical application of determining an accurate attention level of clients in a collaboration session, which is then used to delay content downloads in a manner that minimizes the number of users who notice the delay. Additionally, other forms of determining user attention can be combined with this approach to even further increase the accuracy at which user attention level is measured. Measuring attention level can be used in a variety of other applications, such as tracking user engagement, user productivity, and the like.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

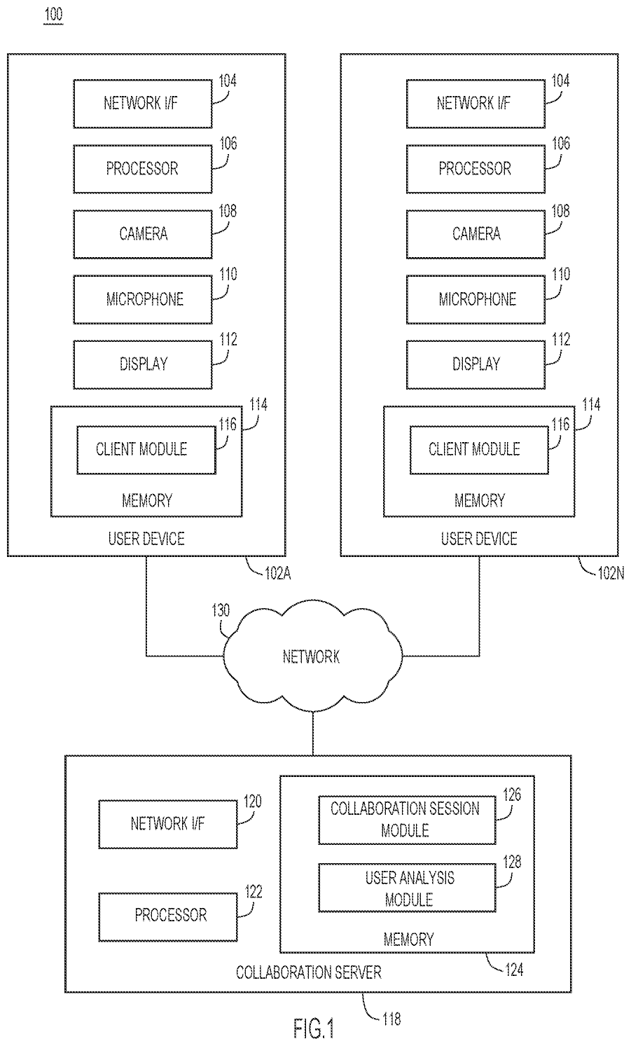

Embodiments will now be described in detail with reference to the Figures. FIG. 1 is a block diagram of a networking environment 100 for providing a collaboration session, according to an example embodiment. As depicted, networking environment 100 includes a plurality of user devices 102A-102N, a collaboration server 118, and a network 130. It is to be understood that the functional division among components of networking environment 100 have been chosen for purposes of explaining various embodiments and is not to be construed as a limiting example.

User devices 102A-120N each include a network interface (I/F) 104, at least one processor 106, a camera 108, a microphone 110, a display 112, and memory 114, which stores instructions for a client module 116. In various embodiments, each user device 102A-120N may include a rack-mounted server, laptop, desktop, smartphone, tablet, or any other programmable electronic device capable of executing computer readable program instructions. Network interface 104 enables components of each user device 102A-102N to send and receive data over a network, such as network 130. Camera 108 may include any video capture device to obtain imagery of a user, such as a webcam, and microphone 110 may include any transducer for converting capturing audio and converting the audio to an electrical signal. Display 112 may include any electronic device capable of presenting information in a visual form. For example, display 112 may be a liquid crystal display (LCD), a cathode ray tube (CRT) display, a light-emitting diode (LED) display, an electronic ink display, a virtual reality or augmented reality display, and the like. In general, user devices 102A-102N may be used by a user to host a collaboration session and/or to participate in a collaboration session.

Client module 116 may include one or more modules or units to perform various functions of the embodiments described below. Client module 116 may be implemented by any combination of any quantity of software and/or hardware modules or units, and may reside within memory 114 of any of user devices 102A-102N for execution by a processor, such as processor 106.

Client module 116 enables a user of each user device 102A-102N to participate in a collaboration session. Client module 116 may enable different user devices 102A-102N to exchange data with each other via a network (e.g., network 130). In one embodiment, client module 116 may transmit data from a user device of a host of the collaboration session to collaboration server 118, which then transmits the data to the other participating user devices 102A-102N. In various embodiments, client module 116 may exchange data comprising text, video, audio, images, or any combinations thereof. In some embodiment, client module 116 receives data corresponding to media content, such as a background image or logo that is presented during the collaboration session. Thus, client module 116 may act as a client for a collaboration session, with collaboration session module 126 of collaboration server 118 functioning as a host or server.

Collaboration server 118 includes a network interface (I/F) 120, at least one processor 122, and memory 124. Memory 124 may store instructions for a collaboration session module 126 and a user analysis module 128. In various embodiments, collaboration server 118 may include a rack-mounted server, laptop, desktop, smartphone, tablet, or any other programmable electronic device capable of executing computer readable program instructions. Network interface 120 enables components of collaboration server 118 to send and receive data over a network, such as network 130. In general, collaboration server 118 hosts collaboration sessions by facilitating the exchange of data, including media content that is presented during collaboration sessions. Collaboration server 118 may also analyze attention data to determine a degree of the attention level of user devices 102A-102N in order to delay content downloads in accordance with present embodiments.

Collaboration session module 126 and/or user analysis module 128 may include one or more modules or units to perform various functions of the embodiments described below. Collaboration session module 126 and/or user analysis module 128 may be implemented by any combination of any quantity of software and/or hardware modules or units, and may reside within memory 124 of collaboration server 118 for execution by a processor, such as processor 122.

Collaboration session module 126 may host collaboration sessions by facilitating the exchange of data between user devices 102A-102N via their client module 116. The collaboration sessions may be text-based, or may include video and/or audio data. In some embodiments, collaboration session module 126 may execute instructions received by a meeting host or an administrator (e.g., a user of a particular user device) to cause user devices 102A-102N of other participants to display particular data, such as a specific view (e.g., a shared view of a particular device's user interface), media content (e.g., a background or logo), a document (e.g., a slideshow presentation), a portion of text, or other visual data, including combinations thereof. Collaboration session module 126 may receive data corresponding to media content from a host or other user, and collaboration session module 126 may cause the user devices 102A-102N to download the media content in an order that is determined by user analysis module 128. In some embodiments, collaboration session module 126 may receive attention data from user devices 102A-102N and provide the attention data to user analysis module 128 so that the data can be processed.

User analysis module 128 may analyze attention data to determine an order for delaying the downloading of media content by particular user devices 102A-102N. In some embodiments, user analysis module 128 may determine the attention level of a client based on a ratio of a window area of the client to the overall screen area of the display. Equation 1 provides an example of this embodiment.

$$Attention level = \frac{Client window area}{Overall screen area} \qquad Equation 1$$

In some embodiments, any portion of the client window that is overlapped by another window may be omitted from consideration when the attention level is calculated. Equation 2 provides an example of this embodiment:

$$Attention level = \frac{Client window area - obscured area}{Overall screen area} \qquad Equation 2$$

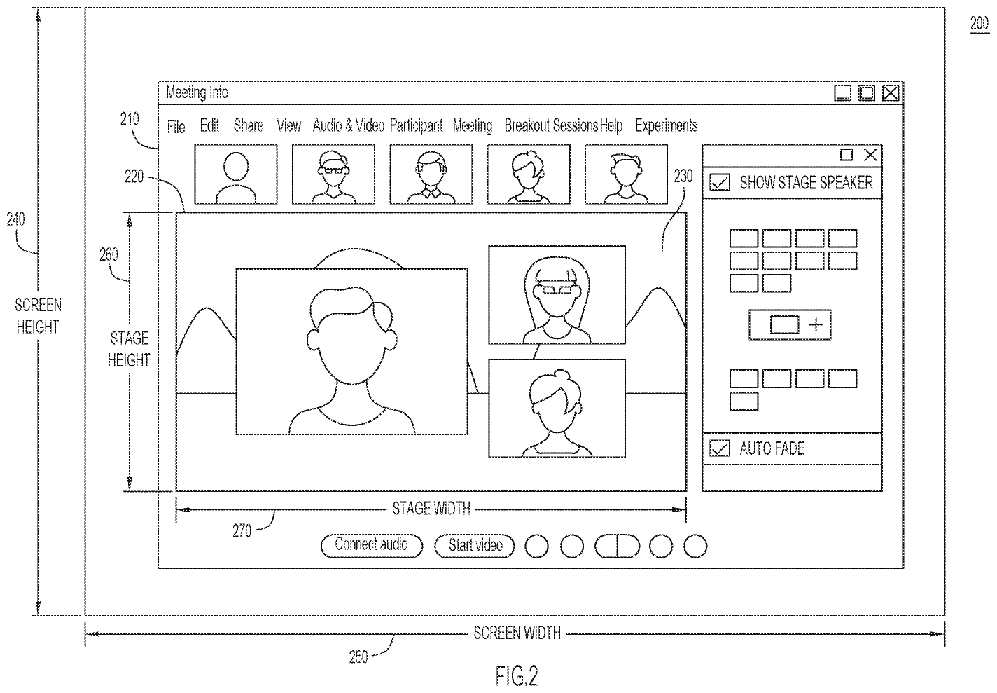

The area for each of the client window, obscured area, and overall screen area may be calculated by multiplying the height by the height of each respective element. These elements are depicted and described in further detail below with regard to FIGS. 2-4 and corresponding text.

The attention data may be obtained by using an Application Programming Interface (API) of a user device's operation system that can obtain data relating to any windows being displayed. The API can determine a z-order of windows, which indicates which windows are above or below other windows, as well as a window size and/or window position for each window.

In some embodiments, the attention level is further based on other attributes, including any of a user eye gaze attribute, a user keystroke attribute, a user mouse movement attribute, a presenter status attribute, a participant status attribute, a user instant messaging activity attribute, a device volume attribute, and a device microphone status attribute. Each of these attributes can be used to adjust (i.e., raise or lower) the attention level of a client, and can be independently weighted so that some attributes have more influence than other attributes.

The user eye gaze attribute may employ gaze tracking (e.g., using data acquired by camera 108) to determine where the user is looking during a collaboration session. If the user is looking at a portion of a display (e.g., display 112) that corresponds to the location of a staging area of the client window (e.g., a subset of the client window in which the media content is being presented), then a high attention level may be indicated. If the user is looking at a portion of a display that does not correspond to staging area, but does correspond to a different portion of the client window, then a medium attention level may be indicated. If the user is looking at the display, but not at the client window, a low attention level may be indicated. If the user is not looking at the display, or the user is not present (e.g., as determined using facial recognition), then a very low (or even zero) attention level can be indicated.

The user keystroke attribute may be determined based on whether or not the user is providing input through a keyboard device, and the user mouse movement attribute may be determined based on whether the user is providing input via a mouse. These attributes may indicate a higher attention level if the user is providing the input to interact with the client application, and a lower attention level if the user is providing the input to interact with a different application.

The presenter status attribute may indicate a high attention level, and can be determined based on the user's role being that of a host or other presenter in the collaboration session. Similarly, the participant status attribute may indicate a lower attention level, and can be determined when the user's role is a non-host or non-presenter participant (e.g., a presentee).

A user instant messaging activity attribute may indicate a higher attention level, and can be determined based on the user participating in a instant messaging portion of the client application.

A device volume attribute may be determined based on the volume of the audio output of a user device. For example, a higher volume may indicate a higher attention level, and a lower volume or muted status may indicate a lower (or zero) attention level. However, if there is audio output from other applications (e.g., if the user is playing music), then a lower attention level may be indicated. If the output audio device includes a headset, headphones, or ear buds, then a higher attention level may be indicated than if the output device includes speakers (e.g., desktop speakers or speakers integrated into the user device).

A device microphone status attribute may be determined based on the degree of ambient noise. If there is a higher level of ambient noise, a lower attention level may be indicated, and/or if there is a lower level of ambient noise, a lower attention level may be indicated. If the microphone status indicates that the user is providing audio input to the client (e.g., the user is currently speaking to other users), then a higher attention level may be indicated.

Accordingly, user analysis module 128 determines a priority for each user device 102A-102N for downloading media content using their respective attention levels. The devices may be sorted based on their attention levels, and broken down into subsets that have different delays applied. For example, a first subset having the highest attention levels may encounter little to no delay (e.g., by being served the content as soon as possible to within one second), a second subset may receive the media data after the first subset (e.g., after one second but before two seconds), and the like. It should be appreciated that the number of subsets and the lengths of each delay can be any desired values, and in various embodiments, the subsets may or may not have the same number of clients and/or the delays may vary from one subset to another.

Network 130 may include a local area network (LAN), a wide area network (WAN) such as the Internet, or a combination of the two, and includes wired, wireless, or fiber optic connections. In general, network 130 can be any combination of connections and protocols known in the art that will support communications between user devices 102A-102N and collaboration server 118 via their respective network interfaces in accordance with the described embodiments.

FIGS. 2-4 are diagrams depicting graphical user interfaces, according to example embodiments. With reference now to FIG. 2, a graphical user interface 200 is shown according to an example embodiment in which a client window 210 is included. Client window 210 includes a staging area 220 in which media content 230 may be presented. As depicted, media content 230 serves as a background for a collaboration session.

Graphical user interface 200 has an area that is defined by a screen height 240 and a screen width 250, and staging area 220 has an area that is defined by a stage height 260 and stage width 270. Since screen height 240 and screen width 250 are larger than stage height 260 and stage width 270, respectively, staging area 220 has a smaller area than graphical user interface 200. Thus, an attention level for this depicted embodiment may be determined by dividing the area of staging area 220 by the area of graphical user interface 200.

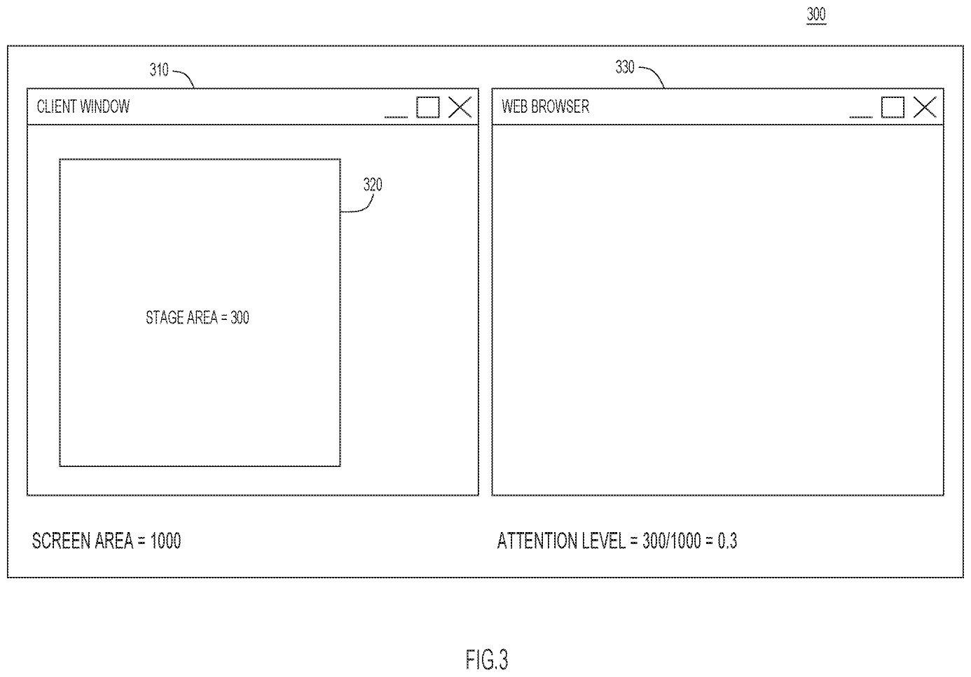

With reference now to FIG. 3, a graphical user interface 300 is depicted having a client window 310 in which a smaller staging area 320 is included, and another window corresponding to a web browser 330. In the depicted example, graphical user interface 300 has an area of 1,000 units, which can include pixels, centimeters (cm), inches (in), points (pt), or any other unit suitable for measuring dimensions of a graphical user interface. Staging area 320 has an area of 300 units. As web browser 330 does not overlap staging area 320, the attention level for this depicted example may be determined by dividing 300/1000 to arrive at an attention level of 0.3.

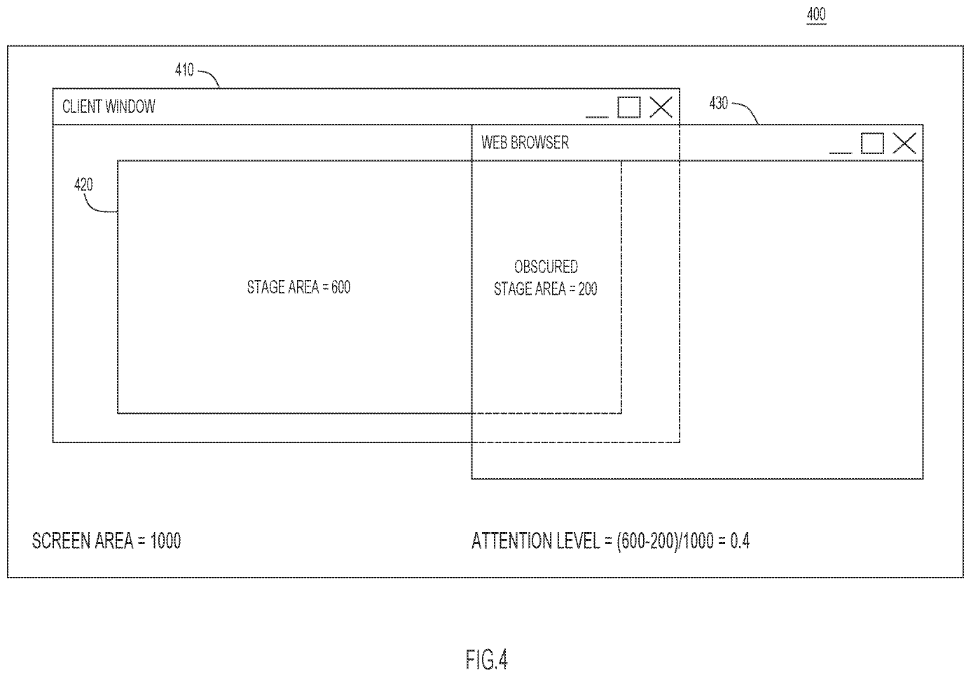

With reference not to FIG. 4, a graphical user interface 400 is depicted having a client window 410 in which a smaller staging area 420 is included, an another window corresponding to a web browser 430. In this depicted embodiment, web browser 430 partially overlaps staging area 420 by an area of 200 units. As graphical user interface 400 has an area of 1,000 units, and staging area 420 has an area of 600 units (200 of which are obscured), the attention level may be calculated as (600−200)/1,000=0.4 in this depicted embodiment.

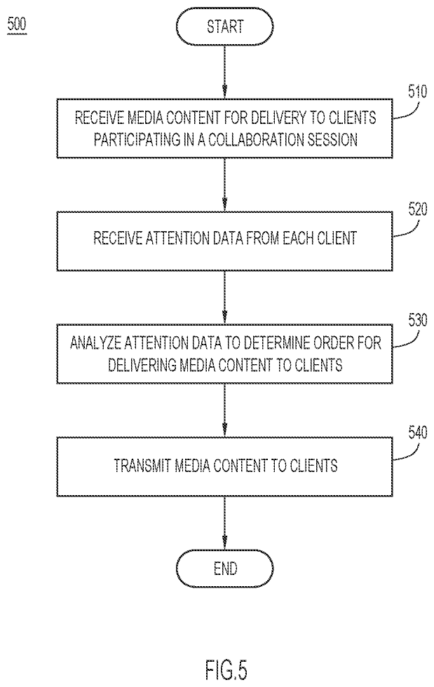

FIG. 5 is a flow chart of a method 500 of transmitting media content during a collaboration session, according to an example embodiment.

Media content is received for delivery to clients that are participating in a collaboration session at operation 510. The media content may be received by a server (e.g., collaboration server 118) that hosts a collaboration session, and can be provided by a participant of the collaboration session, such as a host, administrator, or other participant. The media content may be displayed in a staging area portion of the client application for the collaboration session, and in various embodiments, the media content may be an image (e.g., a logo or background image), a video, a document (including text and/or other graphical content), and the like.

Attention data is received from each client at operation 520. In response to receiving the media content, the server may request attention data from each client. Alternatively, each client may provide attention data to the server at the beginning of the collaboration session, when the client joins, and/or periodically (e.g., every second, every ten seconds, every minute, etc.). The attention data may indicate a client window size (i.e., screen occupancy of the staging area) and overall size of the user device's display, and may further indicate any portion of the client window that is obscured (e.g., overlapped) by another application's window. In some embodiments, the attention data may further indicate attributes such as a user eye gaze attribute, a user keystroke attribute, a user mouse movement attribute, a presenter status attribute, a participant status attribute, a user instant messaging activity attribute, a device volume attribute, and/or a device microphone status attribute.

The attention data is analyzed to determine an order for delivering the media content to the clients at operation 530. The attention data can be analyzed to obtain an attention level by dividing the area of the client window's staging area by the overall area of the user device's display to arrive at a numerical ratio that can range between zero and one. However, in other embodiments, the attention level may be the inverse of this ratio (e.g., the overall screen area may be divided by screen occupancy of the client window), or any other mathematical form of comparing the relative areas may be employed. In some embodiments, any portion of the staging area that is overlapped by another window may be deducted from the areal value of the staging area before dividing by the overall screen area.

In embodiments in which the attention data includes other attributes, the attention level may be adjusted based on those other attributes. For example, any of a user eye gaze attribute, a user keystroke attribute, a user mouse movement attribute, a presenter status attribute, a participant status attribute, a user instant messaging activity attribute, a device volume attribute, and/or a device microphone status attribute can cause the attention level to be adjusted (e.g., raised or lowered) based on predefined adjustment values for each attribute. In some embodiment, different weights may be applied to different attributes so that some attributes may have a stronger or weaker influence over the attention level than other attributes. While the attention data may be analyzed accordingly by the server, it should be appreciated that in other embodiments, attention data may be analyzed by each user device (i.e., locally), and the attention level can then be transmitted to the server.

When the server obtains the attention level for each client in a collaboration session, the server may then determine an order for providing the media content to each client by ranking the clients according to their attention levels. Thus, clients whose attention levels indicate greater user engagement will receive the media content before clients whose attention levels indicate less user engagement. In some embodiments, the server may divide the clients into two or more subsets according to the determined order, and permit the clients to download the media content in groups, beginning with the subset whose clients' attention levels indicate greater user engagement and proceeding according to the determined order.

The media content is transmitted to the clients in the determined order at operation 540. Each client may download the media content according to the determined order, and once a client receives the media content, the media content may be displayed in the staging area of the client window.

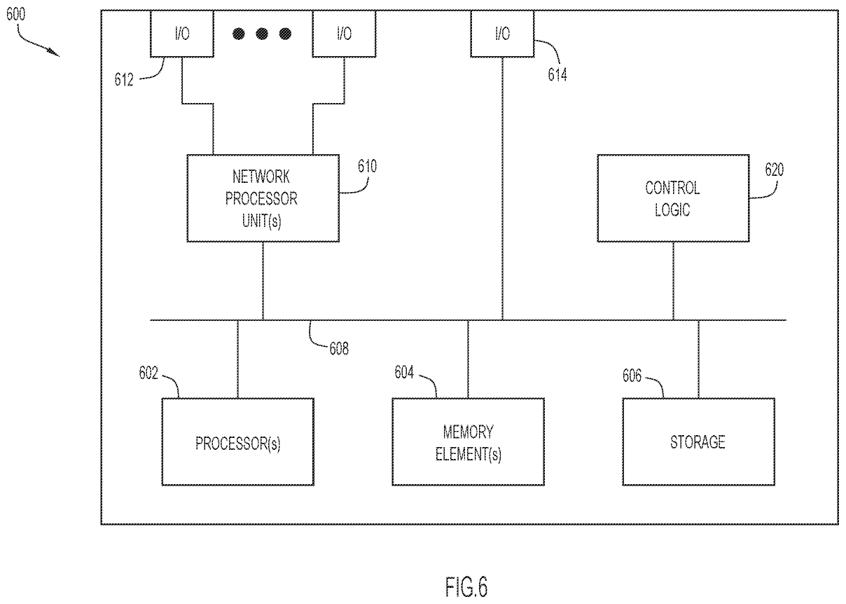

Referring now to FIG. 6, FIG. 6 illustrates a hardware block diagram of a computing device 600 that may perform functions associated with operations discussed herein in connection with the techniques depicted in FIGS. 1-5. In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O 614, and 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O 614 allow for input and output of data and/or information with other entities that may be connected to computing device 600. For example, I/O 614 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

In some aspects, the techniques described herein relate to a computer-implemented method including: receiving, at a server, media content for delivery to a plurality of user devices connected to a collaboration session in which a corresponding plurality of users are participating; receiving, from each user device of the plurality of user devices, attention data indicating a degree to which a user is engaged in the collaboration session, wherein the attention data indicates a screen occupancy of a window corresponding to each user of the plurality of users; analyzing the attention data to determine an order in which the media content is transmitted to each user device of the plurality of user devices, wherein the order prioritizes user devices whose users are more engaged in the collaboration session over user devices whose users are less engaged based on the attention data; and transmitting, by the server, the media content to each user device of the plurality of user devices according to the order.

In some aspects, the techniques described herein relate to a computer-implemented method, wherein the screen occupancy is determined based on a ratio of the window of a particular user to an overall screen area of a display of the user device for the particular user.

In some aspects, the techniques described herein relate to a computer-implemented method, wherein the screen occupancy is further determined by omitting an area of the window of a particular user that is obscured by an overlapping window.

In some aspects, the techniques described herein relate to a computer-implemented method, wherein the attention data further indicates, for each user, one or more attributes selected from a group of: a user eye gaze attribute, a user keystroke attribute, a user mouse movement attribute, a presenter status attribute, a participant status attribute, a user instant messaging activity attribute, a device volume attribute, and a device microphone status attribute.

In some aspects, the techniques described herein relate to a computer-implemented method, wherein the attention data is obtained via an application programming interface that accesses an operating system executing in each user device of the plurality of user devices.

In some aspects, the techniques described herein relate to a computer-implemented method, wherein the media content includes one or more of: image data, video data, and audio data.

In some aspects, the techniques described herein relate to a computer-implemented method, wherein determining the order includes dividing the plurality of user devices into at least a first subset and a second subset, and wherein the media content is transmitted to each user device in the first subset prior to transmitting to each user device in the second subset.

In some aspects, the techniques described herein relate to a computer system including: one or more computer processors; one or more computer readable storage media; and program instructions stored on the one or more computer readable storage media for execution by at least one of the one or more computer processors, the program instructions including instructions to: receive, at the computer system, media content for delivery to a plurality of user devices connected to a collaboration session in which a corresponding plurality of users are participating; receive, from each user device of the plurality of user devices, attention data indicating a degree to which a user is engaged in the collaboration session, wherein the attention data indicates a screen occupancy of a window corresponding to each user of the plurality of users; analyze the attention data to determine an order in which the media content is transmitted to each user device of the plurality of user devices, wherein the order prioritizes user devices whose users are more engaged in the collaboration session over user devices whose users are less engaged based on the attention data; and transmit, by the server, the media content to each user device of the plurality of user devices according to the order.

In some aspects, the techniques described herein relate to a computer system, wherein the screen occupancy is determined based on a ratio of the window of a particular user to an overall screen area of a display of the user device for the particular user.

In some aspects, the techniques described herein relate to a computer system, wherein the screen occupancy is further determined by omitting an area of the window of a particular user that is obscured by an overlapping window.

In some aspects, the techniques described herein relate to a computer system, wherein the attention data further indicates, for each user, one or more attributes selected from a group of: a user eye gaze attribute, a user keystroke attribute, a user mouse movement attribute, a presenter status attribute, a participant status attribute, a user instant messaging activity attribute, a device volume attribute, and a device microphone status attribute.

In some aspects, the techniques described herein relate to a computer system, wherein the attention data is obtained via an application programming interface that accesses an operating system executing in each user device of the plurality of user devices.

In some aspects, the techniques described herein relate to a computer system, wherein the media content includes one or more of: image data, video data, and audio data.

In some aspects, the techniques described herein relate to a computer system, wherein the instructions to determine the order include instructions to divide the plurality of user devices into at least a first subset and a second subset, and wherein the media content is transmitted to each user device in the first subset prior to transmitting to each user device in the second subset.

In some aspects, the techniques described herein relate to a computer program product including one or more computer readable storage media collectively having program instructions embodied therewith, the program instructions executable by a computer to cause the computer to perform operations including: receive, at the computer system, media content for delivery to a plurality of user devices connected to a collaboration session in which a corresponding plurality of users are participating; receive, from each user device of the plurality of user devices, attention data indicating a degree to which a user is engaged in the collaboration session, wherein the attention data indicates a screen occupancy of a window corresponding to each user of the plurality of users; analyze the attention data to determine an order in which the media content is transmitted to each user device of the plurality of user devices, wherein the order prioritizes user devices whose users are more engaged in the collaboration session over user devices whose users are less engaged based on the attention data; and transmit, by the server, the media content to each user device of the plurality of user devices according to the order.

In some aspects, the techniques described herein relate to a computer program product, wherein the screen occupancy is determined based on a ratio of the window of a particular user to an overall screen area of a display of the user device for the particular user.

In some aspects, the techniques described herein relate to a computer program product, wherein the screen occupancy is further determined by omitting an area of the window of a particular user that is obscured by an overlapping window.

In some aspects, the techniques described herein relate to a computer program product, wherein the attention data further indicates, for each user, one or more attributes selected from a group of: a user eye gaze attribute, a user keystroke attribute, a user mouse movement attribute, a presenter status attribute, a participant status attribute, a user instant messaging activity attribute, a device volume attribute, and a device microphone status attribute.

In some aspects, the techniques described herein relate to a computer program product, wherein the attention data is obtained via an application programming interface that accesses an operating system executing in each user device of the plurality of user devices.

In some aspects, the techniques described herein relate to a computer program product, wherein the media content includes one or more of: image data, video data, and audio data.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A computer-implemented method comprising:
receiving, at a server, media content for delivery to a plurality of user devices connected to a collaboration session in which a corresponding plurality of users are participating;
receiving, from each user device of the plurality of user devices, attention data indicating a degree to which a user is engaged in the collaboration session, wherein the attention data indicates a screen occupancy of a window corresponding to each user of the plurality of users;
analyzing the attention data to determine an order in which the media content is transmitted to each user device of the plurality of user devices, wherein the order prioritizes user devices whose users are more engaged in the collaboration session over user devices whose users are less engaged based on the attention data, wherein the order is determined by dividing the plurality of user devices into at least a first subset and a second subset; and
transmitting, by the server, the media content to each user device of the plurality of user devices according to the order by applying a delay in transmission of the media content between the at least first subset and the second subset such that the media content is transmitted to user devices in the first subset prior to initiating the transmitting of the media content to user devices in the second subset.

2. The computer-implemented method of claim 1, wherein the screen occupancy is determined based on a ratio of the window of a particular user to an overall screen area of a display of the user device for the particular user.

3. The computer-implemented method of claim 2, wherein the screen occupancy is further determined by omitting an area of the window of a particular user that is obscured by an overlapping window.

4. The computer-implemented method of claim 1, wherein the attention data further indicates, for each user, one or more attributes selected from a group of: a user eye gaze attribute, a user keystroke attribute, a user mouse movement attribute, a presenter status attribute, a participant status attribute, a user instant messaging activity attribute, a device volume attribute, and a device microphone status attribute.

5. The computer-implemented method of claim 1, wherein the attention data is obtained via an application programming interface that accesses an operating system executing in each user device of the plurality of user devices.

6. The computer-implemented method of claim 1, wherein the media content includes one or more of: image data, video data, and audio data.

7. (canceled)

8. A computer system comprising:
one or more computer processors;
one or more computer readable storage media; and
program instructions stored on the one or more computer readable storage media for execution by at least one of the one or more computer processors, the program instructions comprising instructions to:
receive, at the computer system, media content for delivery to a plurality of user devices connected to a collaboration session in which a corresponding plurality of users are participating;
receive, from each user device of the plurality of user devices, attention data indicating a degree to which a user is engaged in the collaboration session, wherein the attention data indicates a screen occupancy of a window corresponding to each user of the plurality of users;
analyze the attention data to determine an order in which the media content is transmitted to each user device of the plurality of user devices, wherein the order prioritizes user devices whose users are more engaged in the collaboration session over user devices whose users are less engaged based on the attention data, wherein the order is determined by dividing the plurality of user devices into at least a first subset and a second subset; and
transmit, by the computer system, the media content to each user device of the plurality of user devices according to the order by applying a delay in transmission of the media content between the at least first subset and the second subset such that the media content is transmitted to user devices in the first subset prior to initiating transmission of the media content to user devices in the second subset.

9. The computer system of claim 8, wherein the screen occupancy is determined based on a ratio of the window of a particular user to an overall screen area of a display of the user device for the particular user.

10. The computer system of claim 9, wherein the screen occupancy is further determined by omitting an area of the window of a particular user that is obscured by an overlapping window.

11. The computer system of claim 8, wherein the attention data further indicates, for each user, one or more attributes selected from a group of: a user eye gaze attribute, a user keystroke attribute, a user mouse movement attribute, a presenter status attribute, a participant status attribute, a user instant messaging activity attribute, a device volume attribute, and a device microphone status attribute.

12. The computer system of claim 8, wherein the attention data is obtained via an application programming interface that accesses an operating system executing in each user device of the plurality of user devices.

13. The computer system of claim 8, wherein the media content includes one or more of: image data, video data, and audio data.

14. (canceled)

15. A computer program product comprising one or more computer readable storage media collectively having program instructions embodied therewith, the program instructions executable by a computer to cause the computer to perform operations including:
receive, at a server, media content for delivery to a plurality of user devices connected to a collaboration session in which a corresponding plurality of users are participating;
receive, from each user device of the plurality of user devices, attention data indicating a degree to which a user is engaged in the collaboration session, wherein the attention data indicates a screen occupancy of a window corresponding to each user of the plurality of users;
analyze the attention data to determine an order in which the media content is transmitted to each user device of the plurality of user devices, wherein the order prioritizes user devices whose users are more engaged in the collaboration session over user devices whose users are less engaged based on the attention data, wherein the order is determined by dividing the plurality of user devices into at least a first subset and a second subset; and
transmit, by the server, the media content to each user device of the plurality of user devices according to the order by applying a delay in transmission of the media content between the at least first subset and the second subset such that the media content is transmitted to user devices in the first subset prior to initiating transmission of the media content to user devices in the second subset.

16. The computer program product of claim 15, wherein the screen occupancy is determined based on a ratio of the window of a particular user to an overall screen area of a display of the user device for the particular user.

17. The computer program product of claim 16, wherein the screen occupancy is further determined by omitting an area of the window of a particular user that is obscured by an overlapping window.

18. The computer program product of claim 15, wherein the attention data further indicates, for each user, one or more attributes selected from a group of: a user eye gaze attribute, a user keystroke attribute, a user mouse movement attribute, a presenter status attribute, a participant status attribute, a user instant messaging activity attribute, a device volume attribute, and a device microphone status attribute.

19. The computer program product of claim 15, wherein the attention data is obtained via an application programming interface that accesses an operating system executing in each user device of the plurality of user devices.

20. The computer program product of claim 15, wherein the media content includes one or more of: image data, video data, and audio data.

21. The computer-implemented method of claim 4, wherein the user eye gaze attribute indicated by the attention data comprises an indication that the user is looking at a portion of a display of the user device that corresponds to a location in which the media content is to be presented versus another portion of the display.

22. The computer system of claim 11, wherein the user eye gaze attribute indicated by the attention data comprises an indication that the user is looking at a portion of a display of the user device that corresponds to a location in which the media content is to be presented versus another portion of the display.
